(19) United States
(12) Patent Application Publication
(10) Pub. No.: US 2019/0204518 A1
(43) Pub. Date: Jul. 4, 2019

(54) FIBER TRANSMISSION DEVICE

(71) Applicant: Kui-Hsien Huang, Taipei City (TW)

(72) Inventor: Kui-Hsien Huang, Taipei City (TW)

(21) Appl. No.: 15/856,092

(22) Filed: Dec. 28, 2017

(51) Int. Cl. G02B 6/42

(52) U.S. Cl. CPC G02B 6/4284; G02B 6/4255; G02B 6/4292; G02B 6/428

(57) ABSTRACT

The present invention provides a fiber transmission device including a fiber optic connector, a receiver, and a control circuit board; wherein an optical fiber core is set inside the fiber optic connector; and the receiver sets a plurality of pins. The control circuit board is electrically connected with the plural pins of the receiver. A first signal, such as the optical signal, received by the receiver is transformed into a second signal, such as the electric signal, and then output to the control circuit board through the pins, and then the control circuit board is electrically connected with the transmission line having a signal connector, such as a USB Type-C connector, an HDMI connector, . . . , etc. Thus, achieving that the optical signal can be directly transformed into the electric signal and output the signal through the transmission line and the signal connector which does not need a conventional external signal adapter.

### TECHNICAL FIELD OF THE INVENTION

The present invention provides a fiber transmission device, especially relates to a first signal, such as the optical signal, received by the receiver directly set inside the fiber optic connector is transformed into a second signal, such as the electric signal to output, and then using the receiver and the control circuit board to electrically connect with the transmission line having a signal connector, such as a USB Type-C connector, an HDMI connector, . . . , etc. Thus, achieving that the optical signal can be directly transformed into the electric signal and output the signal through the transmission line and the signal connector which does not need a conventional external signal adapter.

### DESCRIPTION OF THE PRIOR ART

The optical fiber communication which is a way to transfer the information has been developed for a long time. And, the optical fiber communication is belong to a kind of the wired communication, which plays an important role in the digital era. The optical fiber communication has the advantages of large transmission capacity and good confidentiality, which has generated a revolutionary effect.

Viewing the application of the optical fiber communication, it needs a transmitter to transform the electric signal into the optical signal, and then transfers through the optical fiber transmission line. Besides, the signal receiving end also needs an optical receiver to transform the optical signal back into the electric signal to achieve the objective of the signal transfer.

Considering the conventional optical fiber transmission line, which both ends of it are separately set a fiber optic connector. Therefore when using it, the signal receiving end needs to set an optical signal receiver to provide the fiber optic connector of the optical fiber transmission line for the matching connection.

Therefore when using it, the signal receiving end needs to set an optical signal receiver to provide the fiber optic connector of the optical fiber transmission line for the matching connection.

And, a plurality of electrical signal output ports, such as the USB Type-C, or HDMI signal output port, . . . , etc., are set through the optical signal receiver to provide the electrical signal transmission line, such as the: USB Type-C, HDMI transmission line, . . . , etc., to electrically connect. And finally, transferring the electric signal to the multimedia device through the electrical signal transmission line.

In such way, an external optical signal adapter is needed to transform the optical signal into the electric signal for the optical fiber transmission line of the conventional optical fiber communication.

And then, the electric signal is transferred to the multimedia device through the optical signal adapter, such that it is very inconvenient for usage.

Besides, the conventional optical fiber transmission line is majorly made by the silica glass which will induce a fracture danger when the conventional optical fiber transmission line is bended too severely and such as to increase the usage cost.

### SUMMARY OF THE INVENTION

The fiber transmission device disclosed by the present invention includes a fiber optic connector, a receiver, and a control circuit board; wherein an optical fiber core is set inside the fiber optic connector to transfer a first signal; which the receiver is set inside the fiber optic connector and corresponded to the optical fiber core; and the receiver sets a plurality of pins to output the second signal.

And, the receiver sets a plurality of pins extended to the outside of the fiber optic connector. The control circuit board is set outside the fiber optic connector and electrically connected with the plural pins; wherein the control circuit board can electrically connect with the transmission line having an external signal connector, such as a USB Type-C connector, an HDMI connector, . . . , etc.

The technical characteristic of the present invention is lied in: Using a receiver directly set inside the fiber optic connector to receive a first signal, such as the optical signal, and transform into a second signal, such as the electric signal. And then, the second signal is output to the control circuit board. And then, the second signal is output to the control circuit board through the plural pins.

And then, using the control circuit board to electrically connect with the transmission line having an external signal connector, such as a USB T e-C connector, an HDMI connector, . . . , etc., so as to achieve that the optical signal can be directly transformed into the electric signal which does not need a conventional external signal adapter.

And then, the signal output is achieved by the transmission line and the signal connector, such as a USB Type-C connector, an HDMI connector, . . . , etc., to simplify the complexity for the connection between the optical fiber transmission line and the and the multimedia device. Meanwhile, the aforementioned signal transmission line having the signal connector, such as a USB Type-C connector, an HDMI connector, . . . , etc., is not made by the silica glass, therefore it can further avoid the defect of easy fracture owing to the severe bending. Therefore, it can further avoid the defect of easy fracture owing to the severe bending.

### BRIEF DESCRIPTION OF THE DRAWINGS

FIG. 1 is a perspective view of the optical fiber transmission device according to the present invention.

FIG. 2 is a decomposition diagram of the optical fiber transmission device according to the present invention.

FIG. 3 is a sectional side-view of the optical fiber transmission device according to the present invention.

FIG. 4 is a schematic diagram of one embodiment of the optical fiber transmission device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

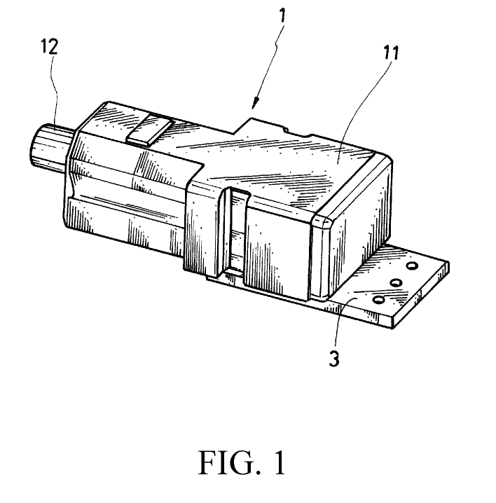

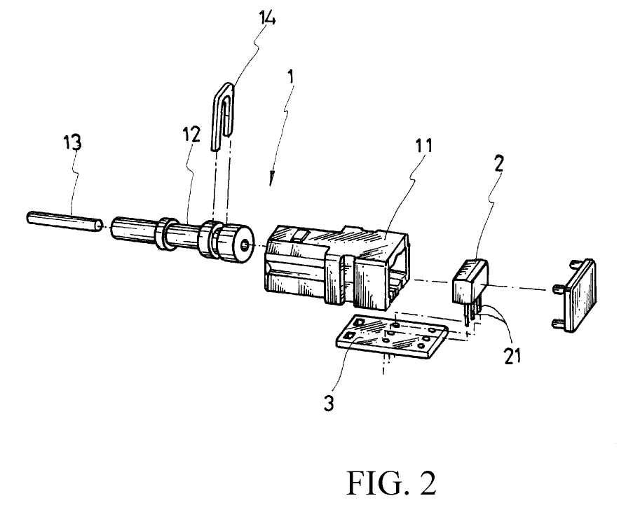

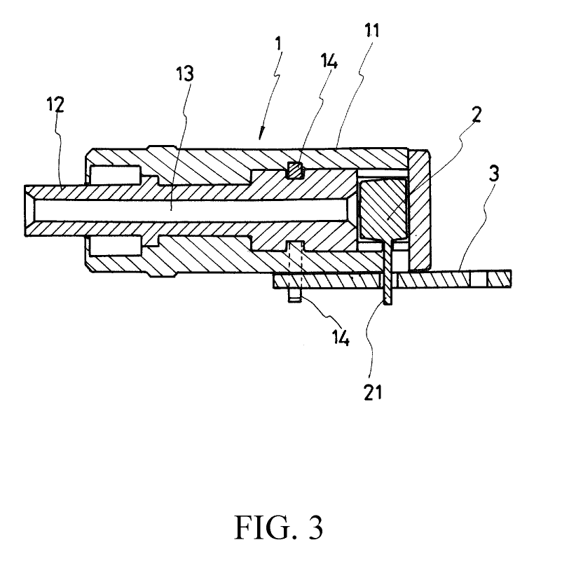

Please refer to FIG. 1 to FIG. 4, the present invention discloses an optical fiber transmission device which includes a fiber optic connector 1, a receiver 2, and a control circuit board 3.

The fiber optic connector 1 includes a main-body 11 which sets a copper-tube 12 inside, and an optical fiber core 13 is set inside the copper-tube 12. At least one fastener 14 is further set inside the main-body 11, and the main-body 11 is made by the inclusiveness-plastic injection molding to pack the outside part of the fastener 14 and the copper-tube 12 inclusively to make the copper-tube 12 firmly combined in the main-body 11. The optical fiber core 13 of the fiber optic connector 1 is used to transfer a first signal, the optical signal.

The receiver 2 set inside the fiber optic connector 1 and corresponded to the optical fiber core 13 can receive an optical signal and transform into an electric signal. And, a plurality of pins 21 which can separately extend to outside of the fiber optic connector 1. The receiver 2 is used to transform the first signal, the optical signal, to a second signal, the electric signal, and then output from the pins 21.

The control circuit board 3 is set outside the fiber optic connector 1 and electrically connected with the plural pins 21.

The fiber optic connector 1 can connect to a preset optical signal transmitter. The second signal transformed by the receiver 2 is transferred to the control circuit board 3 through the pins 21, such that the optical fiber transmission device of the present invention can directly transform the optical signal to the electric signal to output.

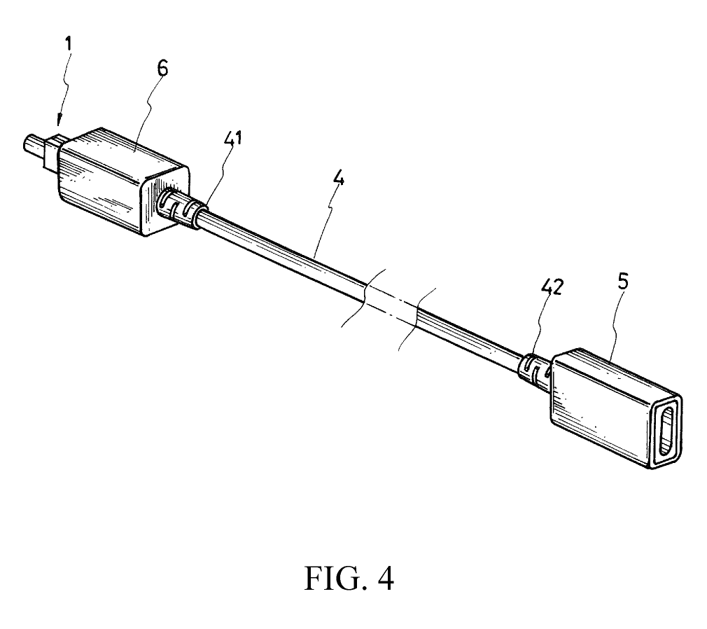

One embodiment of the present invention is shown in FIG. 4; wherein an encapsulation body 6 may be packed outside the fiber optic connector 1 and control circuit board 3. Through the encapsulation of the encapsulation body 6, the fiber optic connector 1 and the control circuit board 3 can form a single form of fiber optic plug.

Besides, the control circuit board 3 can electrically connect with at least one signal transmission line 4, which a first connection end 41 is set at one end and a second connection end 42 is set at another end. The first connection end 41 of the signal transmission line 4 is used to electrically connect with the control circuit board 3 and the second connection end 42 of the signal transmission line 4 is used to electrically connect with a signal connector 5, such as a USB Type-C connector, an HDMI connector, or a connector having other specification. By this, the second signal, the electric signal output from the receiver 2 can be transferred orderly through the control circuit board 3, the signal transmission line 4, and the signal connector 5.

The signal connector 5 can be a signal male connector having arbitrary specification or a signal female socket having arbitrary specification such as a USB Type-C socket, an HDMI connection socket . . . , etc.

The technical characteristic of the present invention is lied in: Using a receiver 2 directly set inside the fiber optic connector 1 to receive the first signal, the optical signal, and transform into a second signal, the electric signal. And then, the second signal is output to the control circuit board 3, and then, the second signal is output to the control circuit board 3 to electrically connect with the signal transmission line 4 to electrically connect with at least one signal connector 5 Finally, the signal connector 5 is connected with an external multimedia device to achieve that the optical signal can be directly transformed into the electric signal which does not need a conventional external signal adapter. And then, the signal output is achieved by the signal transmission line 4 and the signal connector 5 to simplify the complexity for the connection between the optical fiber transmission line and the multimedia device. Besides, the aforementioned signal transmission line 4 is not made by the silica glass, therefore it can further avoid the defect of easy fracture owing to the severe bending.

1. A fiber transmission device, comprising:
a fiber optic connector wherein an optical fiber core is set inside to transfer a first signal;
a receiver set inside the fiber optic connector and corresponded to the optical fiber core to receive the first signal and transform the first signal into a second signal;
wherein the receiver sets a plurality of pins to output the second signal; and
a control circuit board electrically connected with the pins of the receiver;
wherein the optical fiber core extends along an axis line in an axial direction and comprises a circumferential surface extending in the axial direction and circumferentially surrounding the axis line, the optical fiber core having an end that is perpendicular to the axis line and has a circumference connected to the circumferential surface, the end of the optical fiber core being received in the fiber optic connector, the end of the optical fiber core defining an end surface that is perpendicular to the axial direction of the optical fiber core and located inside the fiber optic connector; and
wherein the receiver is arranged to correspond to and face the end surface of the end of the optical fiber core set inside the fiber optic connector, the receiver being located on the axis line of the optical fiber core so that the axis line of the optical fiber core extends through at least one side of the receiver.

2. The fiber transmission device according to claim 1, wherein an encapsulation body is packed outside the fiber optic connector and the control circuit board to make the fiber optic connector and the control circuit board form a single form of fiber optic plug.

3. The fiber transmission device according to claim 1, wherein the control circuit board is electrically connect with at least one signal transmission line, which a first connection end is set at one end and a second connection end is set at another end; wherein the first connection end is used to electrically connect with the control circuit board and the second connection end is used to electrically connect with a signal connector.

4. The fiber transmission device according to claim 3, wherein the signal connector is a signal male connector.

5. The fiber transmission device according to claim 3, wherein the signal connector is a signal female socket.

6. The fiber transmission device according to claim 1, wherein the fiber optic connector comprises a main-body which sets a copper-tube inside, and an optical fiber core is set inside the copper-tube; and a fastener is further set inside the main-body to combine to the outside part of the copper-tube.
